(19) United States
(12) Patent Application Publication
(10) Pub. No.: US 2009/0268359 A1
(43) Pub. Date: Oct. 29, 2009

(54) ELECTROSTATIC DISCHARGE POWER CLAMP WITH IMPROVED ELECTRICAL OVERSTRESS ROBUSTNESS

(75) Inventors: Kiran V. Chatty, Williston, VT (US); Robert J. Gauthier, JR., Hinesburg, VT (US); Junjun Li, Williston, VT (US)

Correspondence Address: CANTOR COLBURN LLP-IBM BURLINGTON, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/109,820

(22) Filed: Apr. 25, 2008

(51) Int. Cl. H02H 9/04

(52) U.S. Cl. 361/56

(57) ABSTRACT

An apparatus for protecting an integrated circuit from electrostatic discharge (ESD) and electrical overstress (EOS) events includes a resistor/capacitor (RC) triggering device configured between a pair of power rails; a silicon controlled rectifier (SCR) triggered by the RC triggering device during an ESD event, wherein the SCR, when activated, acts as a power rail voltage clamp; and a field effect transistor (FET) coupled between the RC triggering device and the SCR, wherein the FET serves as an integrated part of the RC triggering device that triggers the SCR during the ESD event; and wherein the FET also operates in a snapback mode to trigger the SCR during an EOS event that is slower in comparison to the ESD event such that the EOS event would not otherwise cause triggering of the SCR via the RC triggering device itself.

### BACKGROUND

The present invention relates generally to electrostatic discharge (ESD) in integrated circuits, and, more particularly, to an ESD apparatus, method and design structure having improved electrical overstress (EOS) robustness.

ESD events, which can occur both during and after manufacturing of an integrated circuit (IC), can cause substantial damage to the IC. ESD events have become particularly troublesome for complementary metal oxide semiconductor (CMOS) chips because of their low power requirements and extreme sensitivity. A significant factor contributing to this sensitivity to ESD is that the transistors of the circuits are formed from small regions of N-type materials, P-type materials, and thin gate oxides. When a transistor is exposed to an ESD event, the charge applied may cause an extremely high current flow to occur within the device, which in turn can cause permanent damage to the junctions, neighboring gate oxides, interconnects and/or other physical structures.

In particular, there are three general types of ESD events that have been modeled: the human body model (HBM), the machine model (MM) and the charged device model (CDM). The HBM and MM represent discharge current between any two pins on an IC as a result of (respectively) a human body discharging through a chip and a metal tool discharging through a chip. Whereas a human body discharge is relatively slow in terms of rise time and has a unidirectional current in the range of about 1-3 amps, a tool discharge is a relatively rapid event that produces an even higher, bi-directional current into and out of the pin (e.g., about 3-5 amps). In the CDM, the ESD event does not originate from outside the IC device itself, but instead represents the discharge of an IC device to ground. The IC device is charged through the triboelectric effect (frictional charging) or by an external field. The charging of the device substrate itself does not subject the IC to ESD damage, but rather the discharging. As is the case with the MM, the CDM is a very rapid event.

Because of the potential damage from such types of ESD events, on-chip ESD protection circuits for CMOS chips have become commonplace. In general, such protection circuits include ESD clamps configured to maintain the voltage at a power line to a value that is known to be safe for the operating circuits, and that will also not interfere with the operating circuits under normal operating conditions. An ESD clamp circuit is typically constructed between a positive power supply (e.g., V_{DD}) and a ground plane, or a ground plane and a negative power supply (e.g., V_{SS}). The primary purpose of the ESD clamp is to reduce the impedance between the rails V_{DD} and V_{SS} so as to reduce the impedance between the input pad and the V_{SS} rail (i.e., discharge of current between the input to V_{SS}), and to protect the power rails themselves from ESD events.

One specific type of ESD protection circuit is the RC-triggered SCR (silicon controlled rectifier) clamp. RC-triggered SCR clamps are a popular choice for low power/low leakage ESD protection of power supplies, as opposed to large area MOSFET clamps suffering from high static (DC) leakage and/or transient (power-up) leakage. Under power-up conditions, conventional RC-triggered SCRs are non-functional (i.e., they are not triggered). Thus, they offer better static/transient leakage protection. However, with respect to electrical over stress (EOS) conditions in general (which include not only fast transient discharge conditions such as ESD, but also slower transients produced by power line glitches or dropouts, for example), conventional RC-triggered SCRs have been known to experience significant failures.

Accordingly, it would be desirable to implement low power/low leakage ESD protection of power supplies while also protecting against slower time scale transient events (e.g., nanosecond time scale) that would not otherwise trigger conventional RC-triggered SCR clamps.

### SUMMARY

The foregoing discussed drawbacks and deficiencies of the prior art are overcome or alleviated by an apparatus for protecting an integrated circuit from electrostatic discharge (ESD) and electrical overstress (EOS) events, including a resistor/capacitor (RC) triggering device configured between a pair of power rails; a silicon controlled rectifier (SCR) triggered by the RC triggering device during an ESD event, wherein the SCR, when activated, acts as a power rail voltage clamp; and a field effect transistor (FET) coupled between the RC triggering device and the SCR, wherein the FET serves as an integrated part of the RC triggering device that triggers the SCR during the ESD event; and wherein the FET also operates in a snapback mode to trigger the SCR during an EOS event that is slower in comparison to the ESD event such that the EOS event would not otherwise cause triggering of the SCR via the RC triggering device itself.

In another embodiment, a method for protecting an integrated circuit from electrostatic discharge (ESD) and electrical overstress (EOS) events includes configuring a resistor/capacitor (RC) triggering device between a pair of power rails; configuring a silicon controlled rectifier (SCR) to be triggered by the RC triggering device during an ESD event, wherein the SCR, when activated, acts as a power rail voltage clamp; and forming a field effect transistor (FET) between the RC triggering device and the SCR, wherein the FET serves as an integrated part of the RC triggering device that triggers the SCR during the ESD event; and wherein the FET also operates in a snapback mode to trigger the SCR during an EOS event that is slower in comparison to the ESD event such that the EOS event would not otherwise cause triggering of the SCR via the RC triggering device itself.

In another embodiment, a design structure embodied in a machine readable medium used in a design process, the design structure including an apparatus for protecting an integrated circuit from electrostatic discharge (ESD) and electrical overstress (EOS) events, including a resistor/capacitor (RC) triggering device configured between a pair of power rails; a silicon controlled rectifier (SCR) triggered by the RC triggering device during an ESD event, wherein the SCR, when activated, acts as a power rail voltage clamp; and a field effect transistor (FET) coupled between the RC triggering device and the SCR, wherein the FET serves as an integrated part of the RC triggering device that triggers the SCR during the ESD event; and wherein the FET also operates in a snapback mode to trigger the SCR during an EOS event that is slower in comparison to the ESD event such that the EOS event would not otherwise cause triggering of the SCR via the RC triggering device itself.

### BRIEF DESCRIPTION OF THE DRAWINGS

Referring to the exemplary drawings wherein like elements are numbered alike in the several Figures:

FIG. 1(a) is a schematic diagram of a conventional RC-triggered SCR clamp circuit used for ESD protection;

FIG. 1(b) is another schematic representation of the conventional RC-triggered SCR clamp circuit of FIG. 1(a), illustrating the equivalent circuit of the doped regions of the SCR;

FIG. 2 is a schematic diagram of a conventional diode-triggered SCR clamp circuit used for ESD protection;

FIG. 3 is a schematic diagram of an improved RC-triggered SCR clamp circuit used for ESD protection having improved EOS robustness, in accordance with an embodiment of the invention;

FIG. 4 is a schematic diagram of an opposite polarity version of the improved RC-triggered SCR clamp circuit of FIG. 3, in accordance with an alternative embodiment of the invention;

FIGS. 5(a) and 5(b) are current and voltage curves, respectively, illustrating the performance of the RC-triggered SCR clamp of FIG. 3 during a nanosecond time scale ESD event;

FIGS. 6(a) and 6(b) are current and voltage curves, respectively, illustrating the performance of the RC-triggered SCR clamp of FIG. 3 during a millisecond time scale EOS event; and

FIG. 7 is a flow diagram of an exemplary design process used in semiconductor design, manufacturing, and/or test.

### DETAILED DESCRIPTION

Disclosed herein is a novel apparatus, method, and design structure embodied in a machine readable medium used in a design process, wherein a power clamp is designed to activate during both an electrical overstress event (e.g., a slow or DC increase in the power supply potential over some critical threshold) and an ESD event. Briefly stated, an RC-triggered SCR clamp is configured with a field effect transistor (FET) disposed between the RC-trigger and the SCR clamp. The FET (e.g., NFET) acts as a normal driver device during an ESD event (i.e., the FET comprises an integrated part of the RC trigger) and the relatively low source/drain resistances do not reduce its effectiveness. However, during a slower electrical overstress event, the NFET is configured so as to be able to conduct current even after it enters its snapback mode, which also turns on the SCR clamp and shorts out the excessive supply voltage. Advantageously, the overall structure has reduced leakage because the NFET would otherwise be replaced by a series of trigger diodes. In the exemplary embodiments described herein, the FET is a silicide-blocked FET in which the source/drain resistance due the lack of silicide causes FET the conduct current even after it enters its snapback mode.

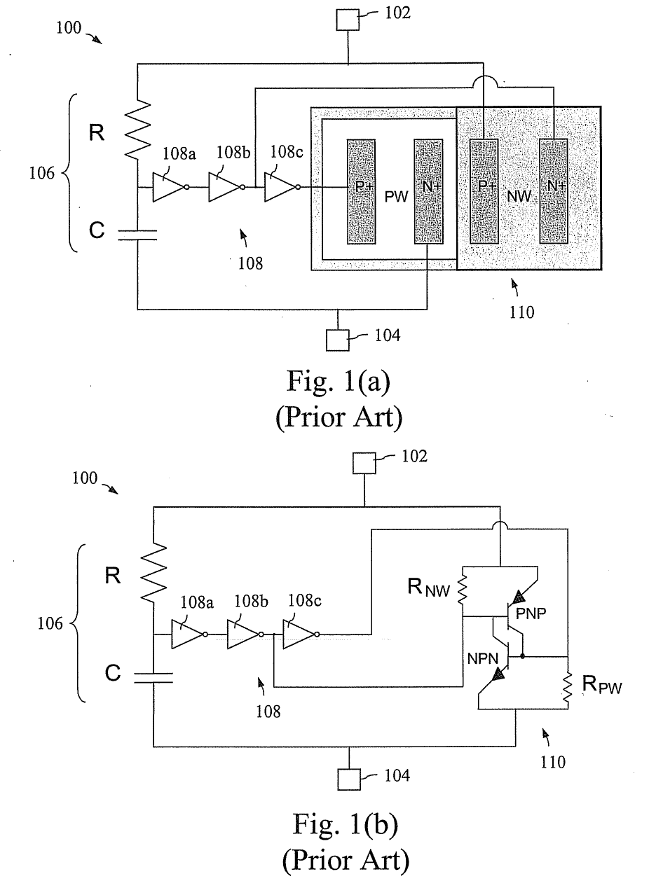

Referring initially to FIGS. 1(a) and 1(b), there is shown a schematic diagram of an existing ESD clamp circuit 100 configured between a pair of power rails 102, 104. In one example, the power rails 102, 104 may nominally be powered by V_{DD} and ground potential. However, the clamp 100 may also be configured between power rails of different voltage levels (e.g., V_{DDX} and V_{DDY}), as well as between ground and V_{SS} (negative potential), for example. As is well known in the art, the ESD clamp circuit 100 includes an RC trigger device 106, an inverter stage 108 (having individual inverters 108a, 108b, 108c) and an SCR 110 serving as a power clamp for sinking ESD current. The N-well and P-well (with associated doped P and N regions therein) are illustrated in FIG. 1(a), while the equivalent latched PNP and NPN bipolar transistors defining the SCR 110 are shown in FIG. 1(b), along with the equivalent N-well and P-well resistances (R_{NW}, R_{PW}).

In order to provide sufficient protection from a fast ESD event (such as the types discussed above), the time constant of the RC trigger device 102 is selected to be sufficiently large enough to cover the duration of the ESD event (e.g., around 1 μs or more). When an ESD voltage spike appears on a power rail pin, the capacitance of the RC trigger 102 initially prevents the voltage at the input of the first inverter 108a from immediately following the rise in the voltage on the power rail. As such, the output of the third inverter 108c (coupled to the base terminal of the NPN bipolar transistor of the SCR 110) will initially remain “high” with respect to the emitter of the NPN bipolar transistor, thereby forward biasing the base-to-emitter junction causing the NPN transistor to conduct current. Concurrently, the output of the second inverter 108b (coupled to the base terminal of the PNP bipolar transistor of the SCR 110) will initially remain “low” with respect to the emitter of the PNP bipolar transistor, thereby forward biasing the base-to-emitter junction causing the PNP transistor to conduct current.

It will be noted that the ESD clamp circuit 100 of FIGS. 1(a) and 1(b) may also be operated by triggering only one of the pair of bipolar transistors in the SCR 110, since current flow initially trigger through one bipolar transistor will result in current flow through the other bipolar transistor coupled thereto. Once triggered, the SCR 110 remains biased in a conductive state so as to limit the rise in voltage on the power rail during the ESD event, thus protecting the IC circuitry.

However, as indicated above, the RC time constant of the trigger 106 (e.g., about 10 ns to about 1 μs) is such that a relatively slower EOS event (e.g., on the order of milliseconds) would not result in the triggering of the SCR 110, since the capacitor voltage would essentially track the slower rise in voltage on rail 102. As a result, the IC circuitry being protected by the ESD clamp 100 is still vulnerable to such slower EOS events.

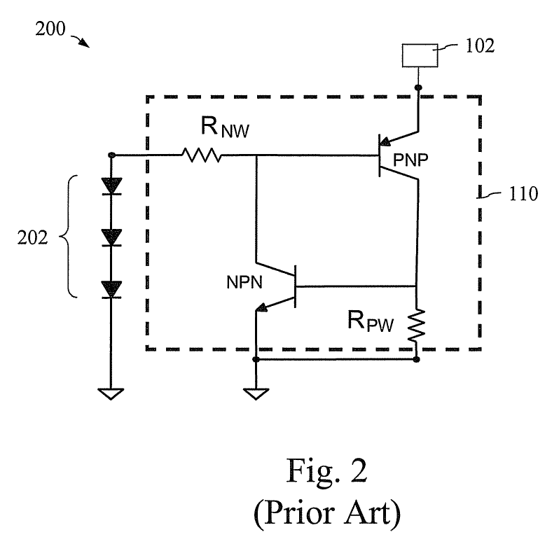

In contrast, FIG. 2 is a schematic diagram of a conventional diode-triggered SCR clamp circuit 200 used for ESD protection. In lieu of an RC triggering device and inverter logic, circuit 200 instead uses a plurality of series connected diodes 202 coupled, through the N-well resistance, to the base of the PNP transistor of the SCR 110. Although such a device triggers the SCR 110 during both a fast ESD event and a relatively slower EOS event, there is a high leakage through the trigger diodes 202, thus representing a significant power savings disadvantage.

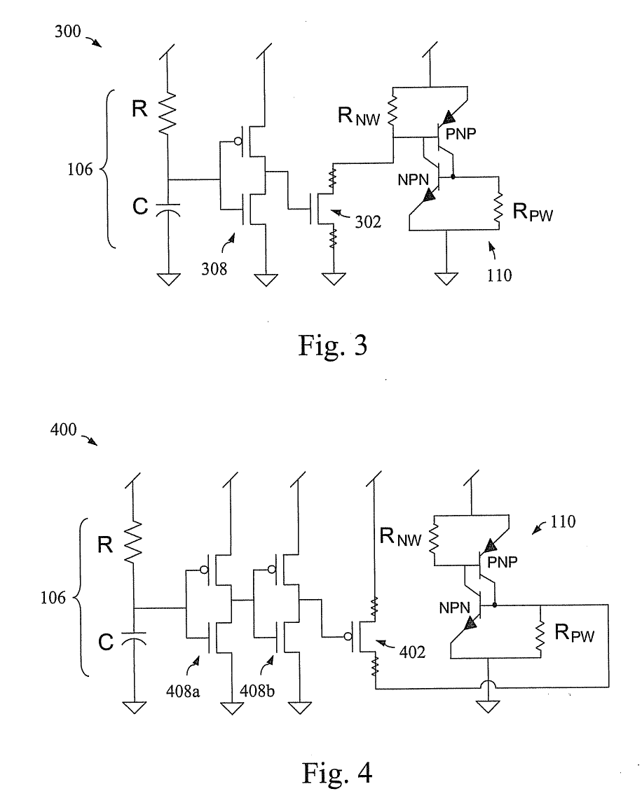

Accordingly, FIG. 3 is a schematic diagram of an improved RC-triggered SCR clamp circuit 300 used for ESD protection having improved EOS robustness, in accordance with an embodiment of the invention. For ease of description, like elements from previous figures are designated with the same reference numbers. In the embodiment depicted, an integrated snapback device 302 in the form of a silicide-blocked NFET is configured between the RC trigger 106/inverter 308 combination and the SCR 110. More specifically, the gate of NFET 302 is coupled to the output of inverter 308, the source is connected to the ground rail, and the source is coupled to the base of the PNP transistor of the SCR 110.

The NFET 302 is “silicide-blocked” in that the source and drain regions thereof are prevented from having a silicide metal (e.g., cobalt, nickel, etc.) formed thereon and annealed during semiconductor device processing so as to reduce the contact resistance thereto, in contrast to other FET devices (not shown) that are included within the IC circuitry protected by the ESD clamp. As a result, the added resistance of the source/drain regions of NFET 302 due to silicide blocking (e.g., on the order of about 5-10 ohms) does not affect the circuit operation for a fast ESD event, but does result in the NFET operating in the snapback region during a slower EOS event.

For example, during an ESD event, the initial voltage spike on the V_{DD} power rail will not be tracked by the voltage across the capacitor C for the duration of the time constant of the RC trigger 106. Thus, the output of the single inverter stage 308 is high, which renders silicide-blocked NFET 302 conducting in the active region and providing the trigger current needed for the SCR 110 to turn on (via the PNP transistor). The SCR trigger voltage for such an event is on the order of about 1.0-1.5 volts.

On the other hand, during a slower EOS event (e.g., a stress on V_{DD} characterized by a slower an longer pulse than an ESD event), the RC timer is not activated since the voltage across the capacitor C tracks the rise on V_{DD}. Consequently, the output of the single (or other odd number) inverter stage 308 is low, meaning that the gate voltage of the silicide-blocked NFET 302 is also low. Nonetheless, the NFET 302 will still serve as a trigger for the SCR 110 because of its operation in the snapback region due to the added resistance of the source and drain regions and the fact that the EOS event results in a positive drain-to-source voltage. The SCR trigger voltage for this type of event is on the order of about 0.7 volts plus the trigger voltage of the silicide-blocked NFET 302.

Again, in order to ensure uniform current distribution through the NFET 302, adequate silicide-blocked resistances should be formed. To this end, the length of the drain silicide-blocked region may be formed on the order of about 2 microns (μm) and the length of the source silicide-blocked region on the order of about 0.4 μm, with the device width the same as the other FETs of the IC device.

The use of a single NFET 302 as an integrated snapback device for an RC-triggered SCR clamp represents just one example of providing EOS protection when the RC trigger does not operate to engage the SCR clamp. For example, a p-type FET (PFET) could also be used, such as illustrated in the SCR clamp circuit 400 of FIG. 4. As more particularly shown in FIG. 4, a silicide-blocked PFET 402 has the gate terminal thereof coupled to the output of a dual inverter stage, comprising inverters 408a, 408b (or other even number of stages). Further, the source of PFET 402 is coupled to V_{DD}, and the drain thereof is coupled to the base of the NPN transistor of the SCR 110.

The operation of circuit 400 during both ESD and EOS event is similar to circuit 300, but opposite in terms of polarity. That is, during an ESD event, the initial voltage spike on the V_{DD} power rail will not be tracked by the voltage across the capacitor C for the duration of the time constant of the RC trigger 106. Thus, the output of the inverter stage 408a is high, meaning the output of inverter stage 408b is low, which renders silicide-blocked PFET 402 conducting in the active region and providing the trigger current needed for the SCR 110 to turn on (via the NPN transistor).

Furthermore, during a slower EOS event, the RC timer is not activated since the voltage across the capacitor C tracks the rise on V_{DD}. Consequently, the output of the inverter stage 408a is low and inverter stage 408b is high, meaning that the gate voltage of the silicide-blocked PFET 402 is also high. Nonetheless, the PFET 302 will still serve as a trigger for the SCR 110 because of its operation in the snapback region due to the added resistance of the source and drain contacts and the fact that the EOS event results in a positive drain-to-source voltage.

As will be further appreciated, both a silicide-blocked NFET and a silicide-blocked PFET can simultaneously be used as part of a dual trigger device, wherein for example, a silicide-blocked NFET may be added to the circuit 400 of FIG. 4 by connecting the gate terminal thereof to the output of inverter stage 408a, the source thereof to ground, and the drain thereof to the base of the PNP transistor, such as shown in FIG. 3.

Although the exemplary embodiments discussed to this point have been presented in terms of silicide-blocked NFET/PFET devices, it will be further appreciated that the either the silicide-blocked NFET, the silicide-blocked PFET (or both) may be replaced with other NFET/PFET devices that have been processed in such a way to ensure their capability to conduct current after snapback. In other words, it is contemplated that other processing techniques may be used in lieu of silicide blocking in order to harden the NFET/PFET under EOS/ESD such that they conduct current following entering the snapback condition.

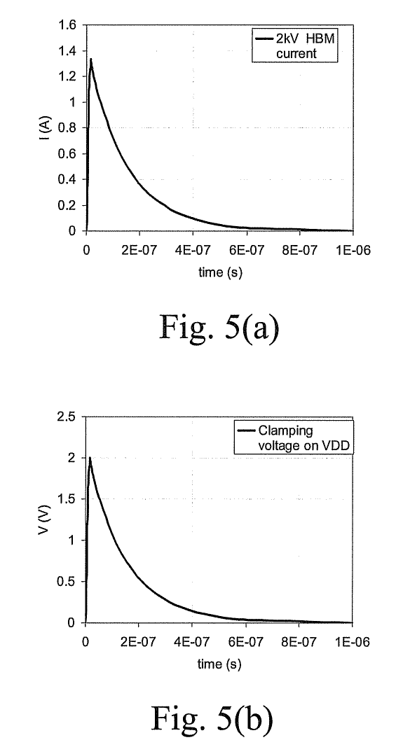

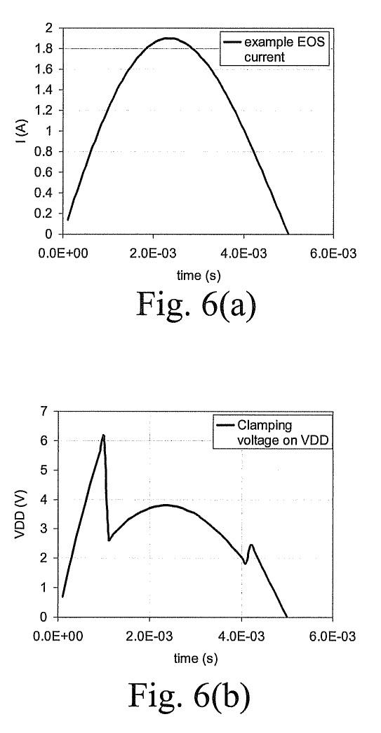

FIGS. 5(a) and 5(b) are current and voltage curves, respectively, illustrating the performance of the RC-triggered SCR clamp of FIG. 3 during a nanosecond time scale ESD event. In particular FIG. 5(a) shows the current spike (up to a peak of about 1.35 A) resulting from a 2 KV HBM ESD event, protected by the circuit of FIG. 3, while FIG. 5(b) shows the corresponding voltage curve for the same event. Moreover, the further performance is further illustrated in a simulated EOS event as shown in FIGS. 6(a) and 6(b). FIG. 6(a) is the resulting EOS event current which peaks around 2 ms, and FIG. 6(b) is the clamping voltage on V_{DD}, which illustrates the NFET 302 operating in a snapback mode.

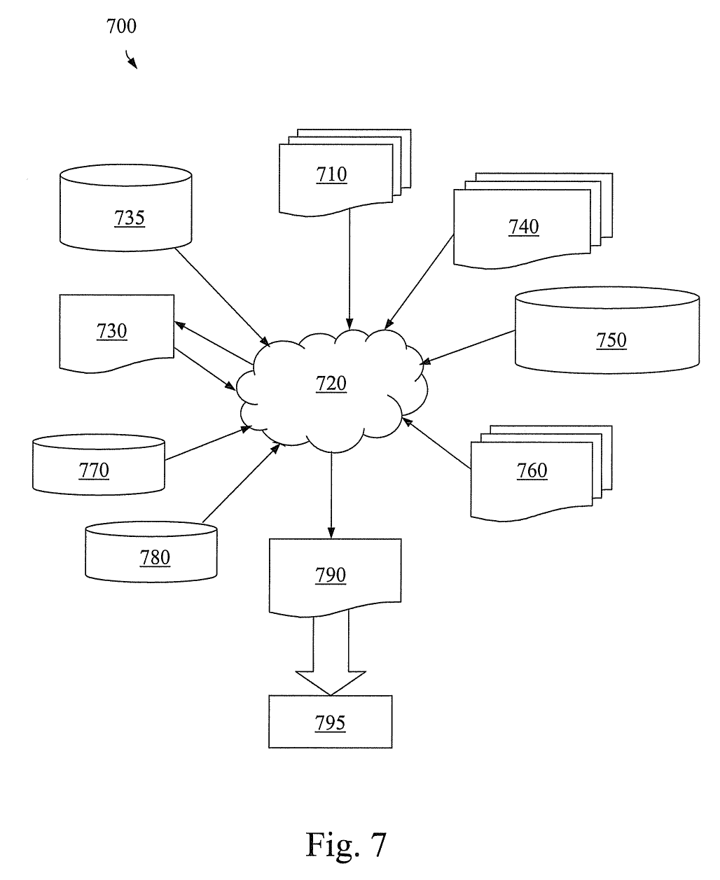

Finally, FIG. 7 is a block diagram illustrating an example of a design flow 700. Design flow 700 may vary depending on the type of IC being designed. For example, a design flow 700 for building an application specific IC (ASIC) will differ from a design flow 700 for designing a standard component. Design structure 710 is preferably an input to a design process 720 and may come from an IP provider, a core developer, or other design company or may be generated by the operator of the design flow, or from other sources. Design structure 710 comprises circuit embodiments 300, 400 in the form of schematics or HDL, a hardware-description language, (e.g., Verilog, VHDL, C, etc.). Design structure 710 may be contained on one or more machine readable medium(s). For example, design structure 710 may be a text file or a graphical representation of circuit embodiments 300, 400 illustrated in FIGS. 3 and 4. Design process 720 synthesizes (or translates) circuit embodiments 300, 400 into a netlist 730, where netlist 730 is, for example, a list of wires, transistors, logic gates, control circuits, I/O, models, etc., and describes the connections to other elements and circuits in an integrated circuit design and recorded on at least one of a machine readable medium. This may be an iterative process in which netlist 730 is resynthesized one or more times depending on design specifications and parameters for the circuit.

Design process 720 includes using a variety of inputs; for example, inputs from library elements 735 which may house a set of commonly used elements, circuits, and devices, including models, layouts, and symbolic representations, for a given manufacturing technology (e.g., different technology nodes, 32 nm, 45 nm, 90 nm, etc.), design specifications 740, characterization data 750, verification data 760, design rules 770, and test data files 580, which may include test patterns and other testing information. Design process 720 further includes, for example, standard circuit design processes such as timing analysis, verification tools, design rule checkers, place and route tools, etc. One of ordinary skill in the art of integrated circuit design can appreciate the extent of possible electronic design automation tools and applications used in design process 720 without deviating from the scope and spirit of the invention. The design structure of the invention embodiments is not limited to any specific design flow.

Design process 720 preferably translates embodiments of the invention as shown in FIGS. 3 and 4, along with any additional integrated circuit design or data (if applicable), into a second design structure 790. Second design structure 790 resides on a storage medium in a data format used for the exchange of layout data of integrated circuits (e.g. information stored in a GDSII (GDS2), GL1, OASIS, or any other suitable format for storing such design structures). Second design structure 790 may comprise information such as, for example, test data files, design content files, manufacturing data, layout parameters, wires, levels of metal, vias, shapes, data for routing through the manufacturing line, and any other data required by a semiconductor manufacturer to produce embodiments of the invention as shown in FIGS. 3 and 4. Second design structure 790 may then proceed to a stage 795 where, for example, second design structure 790: proceeds to tape-out, is released to manufacturing, is released to a mask house, is sent to another design house, is sent back to the customer, etc.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An apparatus for protecting an integrated circuit from electrostatic discharge (ESD) and electrical overstress (EOS) events, comprising:
a resistor/capacitor (RC) triggering device configured between a pair of power rails;
a silicon controlled rectifier (SCR) triggered by the RC triggering device during an ESD event, wherein the SCR, when activated, acts as a power rail voltage clamp; and
a field effect transistor (FET) coupled between the RC triggering device and the SCR, wherein the FET serves as an integrated part of the RC triggering device that triggers the SCR during the ESD event; and
wherein the FET is formed in a manner such that it also operates in a snapback mode to trigger the SCR during an EOS event that is slower in comparison to the ESD event such that the EOS event would not otherwise cause triggering of the SCR via the RC triggering device itself.

2. The apparatus of claim 1, wherein the ESD event is on the order of about 1 microsecond or less, and the EOS event is on the order of milliseconds.

3. The apparatus of claim 1, wherein the FET comprises a silicide-blocked FET.

4. The apparatus of claim 3, wherein the silicide-blocked FET comprises an NFET formed in a manner so as to eliminate silicide contact formation on source and drain regions thereof, resulting in added drain and source series resistance with respect to a silicided FET.

5. The apparatus of claim 4, wherein:
a gate terminal of the NFET is coupled to an output of an odd numbered inverter stage, with an input of the odd numbered inverter stage coupled to the RC trigger device;
a source terminal of the NFET is coupled to a ground rail of the pair of power rails; and
a drain terminal of the NFET is coupled to a base terminal of a bipolar PNP transistor portion of the SCR.

6. The apparatus of claim 3, wherein the silicide-blocked FET comprises a PFET formed in a manner so as to eliminate silicide contact formation on source and drain regions thereof, resulting in added drain and source series resistance with respect to a silicided FET.

7. The apparatus of claim 6, wherein:
a gate terminal of the PFET is coupled to an output of an even numbered inverter stage, with an input of the even numbered inverter stage coupled to the RC trigger device;
a source terminal of the PFET is coupled to a V_{DD} rail of the pair of power rails; and
a drain terminal of the PFET is coupled to a base terminal of a bipolar NPN transistor portion of the SCR.

8. A method for protecting an integrated circuit from electrostatic discharge (ESD) and electrical overstress (EOS) events, the method comprising:
configuring a resistor/capacitor (RC) triggering device between a pair of power rails;
configuring a silicon controlled rectifier (SCR) to be triggered by the RC triggering device during an ESD event, wherein the SCR, when activated, acts as a power rail voltage clamp; and
forming a field effect transistor (FET) between the RC triggering device and the SCR, wherein the FET serves as an integrated part of the RC triggering device that triggers the SCR during the ESD event; and
wherein the FET also operates in a snapback mode to trigger the SCR during an EOS event that is slower in comparison to the ESD event such that the EOS event would not otherwise cause triggering of the SCR via the RC triggering device itself.

9. The method of claim 8, wherein the FET comprises a silicide-blocked NFET formed in a manner so as to eliminate silicide contact formation on source and drain regions thereof, resulting in added drain and source series resistance with respect to a silicided FET.

10. The method of claim 9, further comprising:
coupling a gate terminal of the NFET to an output of an odd numbered inverter stage, with an input of the odd numbered inverter stage coupled to the RC trigger device;
coupling a source terminal of the NFET to a ground rail of the pair of power rails; and
coupling a drain terminal of the NFET to a base terminal of a bipolar PNP transistor portion of the SCR.

11. The method of claim 8, wherein the FET comprises a silicide-blocked PFET formed in a manner so as to eliminate silicide contact formation on source and drain regions thereof, resulting in added drain and source series resistance with respect to a silicided FET.

12. The method of claim 11, further comprising:
coupling a gate terminal of the PFET to an output of an even numbered inverter stage, with an input of the even numbered inverter stage coupled to the RC trigger device;
coupling a source terminal of the PFET to a V_{DD} rail of the pair of power rails; and
coupling a drain terminal of the PFET to a base terminal of a bipolar NPN transistor portion of the SCR.

13. A design structure embodied in a machine readable medium used in a design process, the design structure comprising:
an apparatus for protecting an integrated circuit from electrostatic discharge (ESD) and electrical overstress (EOS) events, including a resistor/capacitor (RC) triggering device configured between a pair of power rails;
a silicon controlled rectifier (SCR) triggered by the RC triggering device during an ESD event, wherein the SCR, when activated, acts as a power rail voltage clamp; and
a field effect transistor (FET) coupled between the RC triggering device and the SCR, wherein the FET serves as an integrated part of the RC triggering device that triggers the SCR during the ESD event; and
wherein the FET is formed in a manner such that it also operates in a snapback mode to trigger the SCR during an EOS event that is slower in comparison to the ESD event such that the EOS event would not otherwise cause triggering of the SCR via the RC triggering device itself.

14. The design structure of claim 12, wherein the FET comprises a silicide-blocked NFET formed in a manner so as to eliminate silicide contact formation on source and drain regions thereof, resulting in added drain and source series resistance with respect to a silicided FET.

15. The design structure of claim 14, wherein:
a gate terminal of the NFET is coupled to an output of an odd numbered inverter stage, with an input of the odd numbered inverter stage coupled to the RC trigger device;
a source terminal of the NFET is coupled to a ground rail of the pair of power rails; and
a drain terminal of the NFET is coupled to a base terminal of a bipolar PNP transistor portion of the SCR.

16. The design structure of claim 13, wherein the FET comprises a silicide-blocked PFET formed in a manner so as to eliminate silicide contact formation on source and drain regions thereof, resulting in added drain and source series resistance with respect to a silicided FET.

17. The design structure of claim 16, wherein:
a gate terminal of the PFET is coupled to an output of an even numbered inverter stage, with an input of the even numbered inverter stage coupled to the RC trigger device;
a source terminal of the PFET is coupled to a V_{DD} rail of the pair of power rails; and
a drain terminal of the PFET is coupled to a base terminal of a bipolar NPN transistor portion of the SCR.

18. The design structure of claim 12, wherein the design structure comprises a netlist describing the apparatus for protecting an integrated circuit from ESD and EOS events.

19. The design structure of claim 12, wherein the design structure resides on storage medium as a data format used for the exchange of layout data of integrated circuits.

20. The design structure of claim 12, wherein the design structure includes at least one of test data files, characterization data, verification data, programming data, or design specifications.
